(19) United States
(12) Patent Application Publication
(10) Pub. No.: US 2013/0263230 A1
(43) Pub. Date: Oct. 3, 2013

(54) METHOD AND SYSTEM FOR STATISTICAL ACCESS CONTROL WITH DATA AGGREGATION

(71) Applicant: ANCHORFREE INC., Mountain View, CA (US)

(72) Inventors: DAVID GORODYANSKY, Mountain View, CA (US); EUGENE LAPIDOUS, Saratoga, CA (US)

(73) Assignee: ANCHORFREE INC., Mountain View, CA (US)

(21) Appl. No.: 13/846,856

(22) Filed: Mar. 18, 2013

Related U.S. Application Data
(60) Provisional application No. 61/618,063, filed on Mar. 30, 2012.

(51) Int. Cl. H04L 29/06

(52) U.S. Cl. CPC H04L 63/08
USPC 726/4

(57) ABSTRACT

Multiple-choice survey is used to increase probability that action is caused by a human user, not by an automated software script. Survey contains some answers that no human user would select, but also more than one correct answer. The answer selected by the user from many correct answers is used as an indication of interest to related subject and/or to display related advertisement. Multiple multi-choice surveys can be presented to the same user over time, to decrease probability of a robot randomly selecting correct answers.

### CROSS-REFERENCE TO RELATED APPLICATIONS

The present application relies upon and claims the benefit of priority of U.S. provisional patent application No. 61/618,063 filed on Mar. 30, 2012, which is incorporated by reference herein.

### BACKGROUND OF THE INVENTION

1. Field of the Invention

This invention relates in general to methods and systems for using challenge-response tests to identify human users (as opposed to software applications) on the Internet.

2. Description of the Related Art

In many cases, it is necessary to limit access to scarce resources (VPN bandwidth, search queries, restricted content) to real users, while prohibiting access from automatic programs (spammers, crawlers etc.).

The process usually involves one computer (a server) asking a user to complete a simple test, which the computer is able to generate and grade. It is sometimes described as a reverse Turing test, because it is administered by a machine and targeted to a human, in contrast to the standard Turing test that is typically administered by a human and targeted to a machine.

One example of such a test is CAPTCHA (http://en.wikipedia.org/wiki/CAPTCHA) that requires that the user type letters or digits from a distorted image that appears on the screen. However, CAPTCHA requires significant user efforts (read the text, type letters) which doesn't serve any other purpose besides gaining access. reCAPTCHA (http://en.wikipedia.org/wiki/Recaptcha) utilizes user's efforts to recognize the text in order to decipher snippets of scanned text difficult for OCR. Why providing additional value, it makes challenge-response tests more difficult (more text to type).

On the other side, there are multiple tests presented to computer users in order to extract lasting information form user's responses. Most of these tests are statistical surveys (http://en.wikipedia.org/wiki/Statistical_survey) containing multiple-choice questions. User's answers are usually aggregated and used for content targeting, recommendations and product marketing.

Main problem with computer surveys is reliability of obtained information. If survey is not mandatory (for instance, one filled by volunteers or incentivized by promotional offers or micro-payments), it is subject to user bias: group of users filling the survey could be different from the group of users accessing the web site or service where survey is presented.

If survey is mandatory (for instance, filling the survey is required to access the content or a service), users often select random answers. One of the solutions that offers such mandatory survey-based access control is SponsorSelect (http://www.sponsorselect.com/).

Therefore, there is a need for systems and methods that address the above-identified problems with challenge-response tests and online surveys and simplify challenge-response tests used to allow access to human users, while utilizing user efforts to obtain information that would remain valuable long after the user has performed the test.

### SUMMARY OF THE INVENTION

The inventive methodology is directed to methods and systems that substantially obviate one or more of the above and other problems associated with conventional techniques for using challenge-response tests to identify human users.

In accordance with one aspect of the inventive methodology, there is provided a computer-implemented method performed in a system comprising a central processing unit and a memory. The inventive method involves: receiving a request to access a resource, the request being received from a request originator; providing to the request originator a response comprising at least one challenge question and a plurality of answer options responsive to the challenge question; receiving from the request originator a choice of one of the plurality of answer options; and allowing or denying the access to the resource based on the received choice of one of the plurality of answer options. In the inventive method, the plurality of answer options comprise at least one answer of a first type which is unlikely to be selected by a human user and at least two answers of a second type, which have high probability of being selected by the human users and which reflect predetermined characteristics of the human user.

In one or more embodiments, the difference between the answers of the first and the second type are obvious to the human user but not obvious to a computer.

In one or more embodiments, allowing or denying the access to the resource is based on a previous pattern of received choices of answer options.

In one or more embodiments, the access to the resource is granted when the request originator selected answers of the second type multiple times in the past.

In one or more embodiments, the inventive method further involves storing information on the received choice of one of the plurality of answer options for a future use.

In one or more embodiments, the inventive method further involves using the stored information on the received choice of one of the plurality of answer options to compute distribution of a parameter reflective of the request originator.

In one or more embodiments, the inventive method further involves using the stored information on the received choice of one of the plurality of answer options to provide content to the request originator.

In one or more embodiments, the challenge question connects the request originator with a group of peers.

In one or more embodiments, the inventive method further involves using received choices of a first plurality of request originators to identify the group of peers.

In one or more embodiments, the inventive method further involves using the identified group of request originators to allow of deny access to subsequent request originators based on the corresponding choices of one of the plurality of answer options.

In one or more embodiments, the resource is a virtual private network service.

In one or more embodiments, if the access to the resource is denied, future requests within a predetermined time-out period are also denied.

In one or more embodiments, the plurality of the answer options are provided to the request originator in a pictorial form.

In one or more embodiments, the inventive method further involves randomly varying an order of the plurality of the answer options.

In one or more embodiments, the access to the resource is only partially denied.

In accordance with one aspect of the inventive methodology, there is provided a computer-readable medium comprising a set of computer-executable instructions, which, when executed by one or more processors, cause the one or more processors to perform a method involving: receiving a request to access a resource, the request being received from a request originator; providing to the request originator a response comprising at least one challenge question and a plurality of answer options responsive to the challenge question; receiving from the request originator a choice of one of the plurality of answer options; and allowing or denying the access to the resource based on the received choice of one of the plurality of answer options. The plurality of answer options comprise at least one answer of a first type which is unlikely to be selected by a human user and at least two answers of a second type, which have high probability of being selected by the human users and which reflect predetermined characteristics of the human user.

In one or more embodiments, the difference between the answers of the first and the second type are obvious to the human user but not obvious to a computer.

In one or more embodiments, allowing or denying the access to the resource is based on a previous pattern of received choices of answer options.

In one or more embodiments, the access to the resource is granted when the request originator selected answers of the second type multiple times in the past.

In accordance with one aspect of the inventive methodology, there is provided a system comprising a central processing unit and a memory storing a set of instructions, the central processing unit being configured by the set of instructions to: receive a request to access a resource, the request being received from a request originator; provide to the request originator a response comprising at least one challenge question and a plurality of answer options responsive to the challenge question; receive from the request originator a choice of one of the plurality of answer options; and allow or deny the access to the resource based on the received choice of one of the plurality of answer options. The plurality of answer options comprise at least one answer of a first type which is unlikely to be selected by a human user and at least two answers of a second type, which have high probability of being selected by the human users and which reflect predetermined characteristics of the human user.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a computer platform upon which the inventive system may be implemented.

FIG. 2 illustrates an exemplary operating sequence of an embodiment of an inventive method for using challenge-response tests to identify human users.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Aspects of the present invention provide systems and methods for simplifying challenge-response tests used to control access to various online and off-line resources, such as information or computing resources, to human users, while utilizing user efforts to derive information that would remain valuable long after the user has completed the test.

One or more embodiments of the invention are designed to handle user's requests to access restricted resources, including, without limitation, a virtual private network system (VPN), a search engine, a restricted content, or any other type of similar online or offline resource. In accordance with one or more embodiments of the invention, user's requests are sent from user's client computer to the inventive challenge-response generator, which may be deployed on a computing device positioned anywhere on the network. In an alternative embodiment, the inventive challenge-response generator may be deployed in a form of a software executing on user's computer.

In one or more embodiments of the invention, the inventive challenge-response generator could be implemented, for example, on a server platform executing a web server software and a database software. As would be appreciated by those of skill in the art, many more alternative implementations or deployments of the inventive challenge-response generator are possible and the present invention is not limited to any one specific implementation or deployment.

In one or more embodiments of the invention, the inventive challenge-response generator is configured to generate a multiple-choice test, which is presented to the user online. To this end, the inventive challenge-response generator may be configured to send HTML content to the user's client computer and receive user's responses again in HTML format.

In one or more embodiments of the invention, the aforesaid test contains a challenge question to the user associated with multiple answers, one of which the user must select as the best response to the challenge question. In one or more embodiments of the invention, the multiple answers presented to the user contain one or more answers of the first type, which have low probability of being selected by a human user and two or more answers of the second type, which have high probability of being selected by a human users and which are designed to reflect certain characteristics of the human user.

In one or more embodiments of the invention, the difference between the answers of the first and the second type should be obvious to the human user but not obvious to a computer without expending prohibitively large amount of processing resources.

In one or more embodiments of the invention, the user's response to the challenge question is sent to a test processor. In one or more embodiments of the invention, the test processor may be deployed as a software executing on a server platform positioned on a network or as a software module deployed on the same computer as the inventive challenge-response generator.

In one or more embodiments of the invention, the inventive test processor makes a decision whether to grant the access to the resource to the user based on user's answers to the challenge question(s). In one embodiment, the inventive test processor is configured to deny access to a resource to the user if the user selects answer of the first type to one or more challenge questions presented to the user.

In another embodiment, granting or denial of the access to a resource is controlled based on the previous pattern of user's selections of the answers to challenge questions. For instance, if the user selected answer of the second type multiple times in the past, he can be granted access to a resource even if he selects one answer of the first type.

In one or more embodiments of the invention, each answer may be associated with a predetermined probability that the user is a human. This probability can be pre-set or, alternatively, adjusted time to time based on comparison of history of answers from multiple users and their subsequent behaviors.

In one or more embodiments of the invention, in addition to determining whether to grant the access to the resource to the user, the one of more answer(s) provided by the user are stored for subsequent use. In one embodiment, answers of the aforesaid second type are aggregated and used to compute distribution of certain parameters reflected in the test answers across the user group. In another embodiment, one or more answers of the user are used to serve offers or content to that individual user. For instance, a user may be presented with a challenge question regarding his or her preferences with respect to makes and models of cars. Thus, users whose answers to the challenge questions reflect that they prefer a specific car make and model may receive offers targeted to that make and model or competing makes and models.

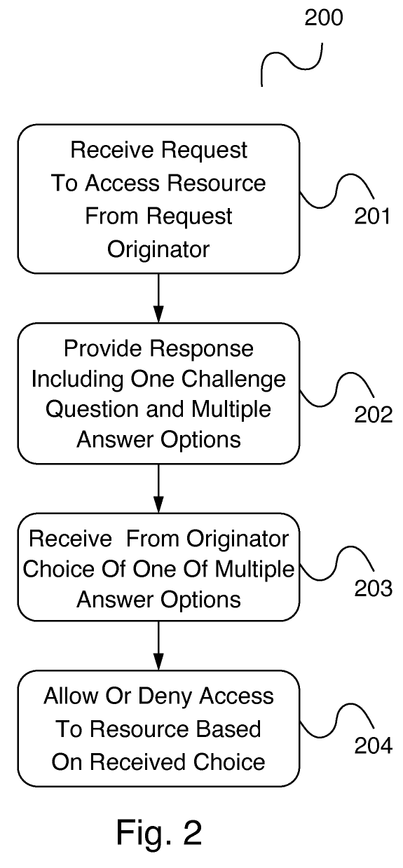

FIG. 2 illustrates an exemplary operating sequence 200 of an embodiment of an inventive method for using challenge-response tests to identify human users. At step 201, the system receives from a request originator, such as a user using a client computer system, a request to access a resource, such as a network storage or computing resource. In response to the receive response, the system is configured to provide to the request originator a response comprising at least one challenge question and multiple possible answer options responsive to the challenge question, see step 202. The user selects one of the multiple possible answer options and sends his selection back to the system. The system receives from the request originator a choice of one of the plurality of answer options at step 203. Finally, the system allows or denies the access to the resource based on the received choice of one of the multiple answer options, see step 204. In one or more embodiments, the multiple answer options include at least one answer of a first type which are unlikely to be selected by a human user and at least two answers of a second type, which have high probability of being selected by the human users and which reflect predetermined characteristics of the human user.

Various exemplary embodiments of the challenge test content will now be described in more detail.

In a first exemplary embodiment, the challenge test includes a challenge question as well as two right answers and one obviously wrong answer. For example, the challenge question may sound like: “Which of these cars is better that the other?” The associated answers, which could be in the form of a text or images, may include 1) Ford Mustang; 2) Toyota Camry; and 3) Tree Frog, with the last answer being obviously a wrong one.

In a second exemplary embodiment, the challenge test includes a challenge question, such as: “Which drink is better on a hot day?” The suggested answers are: “Gin, Wine, Beer, Coke, Water, Oil and Sand.” The aforesaid suggested answers include four possibly right but very different answers, one probably wrong answer (“Oil”), one obviously wrong answer (“Sand”).

In a third exemplary embodiment, the challenge test includes a challenge question, such as: “Which drink is better in the morning?” The suggested answers are: “Orange Juice, Apple Juice, Green Tea, Black Tea, Coffee, Orange Pencil, Apple Tart.” The aforesaid suggested answers include four answers from the same category that could be right answers, as well as two clearly wrong answers that use words from the possibly right answers (“Orange Pencil”, “Apple Tart”).

In a fourth exemplary embodiment, the challenge test includes a challenge question, that connects the user with a group of his peers. One example of such question may be: “Which drink is more popular in your country?” The suggested answers are: “Black Tea, Green Tea, Tea with Milk, Water with Honey.”

If this exemplary test question is offered, for example, in China, the majority of the users answering the aforesaid exemplary question would not select “Tea with Milk” or “Water with Honey”. In this exemplary embodiment, the test processor would be configured to allow the access to the resource to a first set of users, which may include a predetermined number of first users or users who take the test in the predetermined initial time interval.

This first set of users will be allowed access to the resource without regard to their choice of the answer, while subsequent users will be allowed access to the resource based on the frequency of answers selected by real users from their peer group. It should be noted that this type of test is especially difficult for a computer to resolve: test author himself may not know the correct answer until initial answers from the users are aggregated.

In one or more embodiments of the invention, while determining whether to accept user's access request, the inventive test processor may take into account user's history of selecting possible answers. For example, if the percentage of selecting lower-probability answers by the user is above a predetermined threshold, the system may be configured to reject or inhibit the access request by the user. In one embodiment, the system may be programmed not to allow another request for a predetermined duration of time, such as 15 min.

In one or more embodiments of the invention, “incorrect” answer of the aforesaid first type can be generated and rated on multiple levels:
incorrect for a human (human will not classify frog as a car);
incorrect for a group of user peers (most people from China don't drink water with honey); or
incorrect for the same user (user who previously answered questions designed to select mature audience fails to do it again).

In one or more embodiments of the invention, the suggested answers to the challenge question may be presented to the user as text or pictures. For example, answers to challenge question: “What's the better drink?” may be represented by pictures of a water, coke and building.

In one or more embodiments of the invention, the order of correct/incorrect answers presented to the user may be randomly varied.

In one or more embodiments of the invention, the system may be configured not to repeat the same question(s) for the same user.

In one or more embodiments of the invention, the system may be configured not to block access to resource completely upon receiving of an incorrect answer from the user, but limit some aspects of the access, such as: lowering bandwidth, not providing video content to user, not allowing access to a torrent, or imposing other similar restrictions.

In one or more embodiments of the invention, the inventive challenge/response system is used to control access by users to a VPN service.

In one or more embodiments of the invention, the inventive challenge/response system is used to control access by users to specific content, such as newspaper, news, and the like.

In one or more embodiments of the invention, the inventive challenge/response system is used to change the type of questions depending on user's history of answering previous tests. For instance, if it is determined that the user has higher probability of being a human, the inventive system may be configured to offer more of second type questions with more subtle choices or qualifications on the previous choices regarding, for example, specific cars, drinks etc. If the access request is suspected to be originated by a computer program and not human user, the system may offer more choices of the first type.

As it would be appreciated by those of skill in the art, it is not the goal of any challenge/response system to provide absolutely accurate determination whether user is human. In most cases, the system must only increase the share of traffic from human users, while some amount of errors is acceptable.

As it would be also appreciated by those of skill in the art, if some of the answers in the mandatory survey lead to negative consequences (denial of access), this fact would force the user to think about the answers next time instead of selecting them randomly.

As it would be also appreciated by those of skill in the art, one or more embodiments of the inventive challenge and response system provide an easier way to control access to resources by users. In an embodiment of the system, it requires the user to perform only one click instead of typing multiple letters. In addition, one or more embodiments of the inventive challenge and response system provide increased reliability of information without introducing user bias, wherein the user must think what to answer, but all users are subjected to the test.

In one or more embodiments of the invention, instead of using the inventive challenge-response test to determine whether or not the user is human, the system may use answers of the first type to filter out undesired categories of the users (for instance, young people for mature content) and use answers of the second type to extract information about the users (for instance, preferences of mature users).

In one or more embodiments of the invention, the system may use statistical access control as a means to gain information about the user even if accessed content or service allows all types of users, both humans and computers. The fact that user's future privileges (gaining access to the resource, or changing amount or type of the available resource) depend on selecting one of the right answers would force user to think about all answers instead of selecting them randomly.

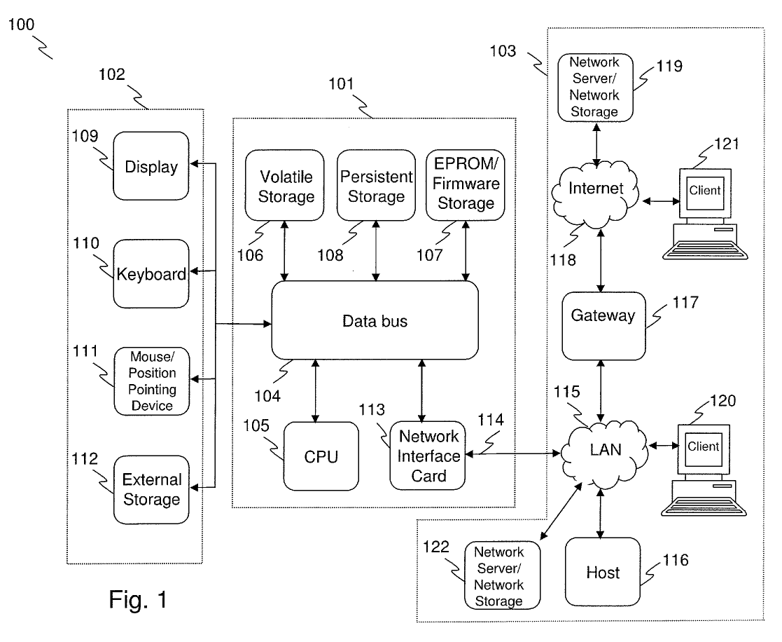

FIG. 1 is a block diagram that illustrates an embodiment of a computer/server system 100 upon which an embodiment of the inventive methodology may be implemented. The system 100 includes a computer/server platform 101, peripheral devices 102 and network resources 103.

The computer platform 101 may include a data bus 105 or other communication mechanism for communicating information across and among various parts of the computer platform 101, and a processor 105 coupled with bus 101 for processing information and performing other computational and control tasks. Computer platform 101 also includes a volatile storage 106, such as a random access memory (RAM) or other dynamic storage device, coupled to bus 105 for storing various information as well as instructions to be executed by processor 105. The volatile storage 106 also may be used for storing temporary variables or other intermediate information during execution of instructions by processor 105. Computer platform 101 may further include a read only memory (ROM or EPROM) 107 or other static storage device coupled to bus 105 for storing static information and instructions for processor 105, such as basic input-output system (BIOS), as well as various system configuration parameters. A persistent storage device 108, such as a magnetic disk, optical disk, or solid-state flash memory device is provided and coupled to bus 101 for storing information and instructions.

Computer platform 101 may be coupled via bus 105 to a display 109, such as a cathode ray tube (CRT), plasma display, or a liquid crystal display (LCD), for displaying information to a system administrator or user of the computer platform 101. An input device 110, including alphanumeric and other keys, is coupled to bus 101 for communicating information and command selections to processor 105. Another type of user input device is cursor control device 111, such as a mouse, a trackball, or cursor direction keys for communicating direction information and command selections to processor 105 and for controlling cursor movement on display 109. This input device typically has two degrees of freedom in two axes, a first axis (e.g., x) and a second axis (e.g., y), that allows the device to specify positions in a plane.

An external storage device 112 may be coupled to the computer platform 101 via bus 105 to provide an extra or removable storage capacity for the computer platform 101. In an embodiment of the computer system 100, the external removable storage device 112 may be used to facilitate exchange of data with other computer systems.

The invention is related to the use of computer system 100 for implementing the techniques described herein. In an embodiment, the inventive system may reside on a machine such as computer platform 101. According to one embodiment of the invention, the techniques described herein are performed by computer system 100 in response to processor 105 executing one or more sequences of one or more instructions contained in the volatile memory 106. Such instructions may be read into volatile memory 106 from another computer-readable medium, such as persistent storage device 108. Execution of the sequences of instructions contained in the volatile memory 106 causes processor 105 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 105 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 108. Volatile media includes dynamic memory, such as volatile storage 106.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 105 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 105. The bus 105 carries the data to the volatile storage 106, from which processor 105 retrieves and executes the instructions. The instructions received by the volatile memory 106 may optionally be stored on persistent storage device 108 either before or after execution by processor 105. The instructions may also be downloaded into the computer platform 101 via Internet using a variety of network data communication protocols well known in the art.

The computer platform 101 also includes a communication interface, such as network interface card 113 coupled to the data bus 105. Communication interface 113 provides a two-way data communication coupling to a network link 115 that is coupled to a local network 115. For example, communication interface 113 may be an integrated services digital network (ISDN) card or a modem to provide a data communication connection to a corresponding type of telephone line. As another example, communication interface 113 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 113 sends and receives electrical, electromagnetic or optical signals that carry digital data streams representing various types of information.

Network link 113 typically provides data communication through one or more networks to other network resources. For example, network link 115 may provide a connection through local network 115 to a host computer 116, or a network storage/server 117. Additionally or alternatively, the network link 113 may connect through gateway/firewall 117 to the wide-area or global network 118, such as an Internet. Thus, the computer platform 101 can access network resources located anywhere on the Internet 118, such as a remote network storage/server 119. On the other hand, the computer platform 101 may also be accessed by clients located anywhere on the local area network 115 and/or the Internet 118. The network clients 120 and 121 may themselves be implemented based on the computer platform similar to the platform 101.

Local network 115 and the Internet 118 both use electrical, electromagnetic or optical signals that carry digital data streams. The signals through the various networks and the signals on network link 115 and through communication interface 113, which carry the digital data to and from computer platform 101, are exemplary forms of carrier waves transporting the information.

Computer platform 101 can send messages and receive data, including program code, through the variety of network(s) including Internet 118 and LAN 115, network link 115 and communication interface 113. In the Internet example, when the system 101 acts as a network server, it might transmit a requested code or data for an application program running on client(s) 120 and/or 121 through Internet 118, gateway/firewall 117, local area network 115 and communication interface 113. Similarly, it may receive code from other network resources.

The received code may be executed by processor 105 as it is received, and/or stored in persistent or volatile storage devices 108 and 106, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the system for using challenge-response tests to identify human users on the Internet. It is intended that the specification and examples be considered as exemplary only, with a true scope and spirit of the invention being indicated by the following claims.

What is claimed is:

1. A computer-implemented method performed in a system comprising a central processing unit and a memory, the method comprising:
a. Receiving a request to access a resource, the request being received from a request originator;
b. Providing to the request originator a response comprising at least one challenge question and a plurality of answer options responsive to the challenge question;
c. Receiving from the request originator a choice of one of the plurality of answer options; and
d. Allowing or denying the access to the resource based on the received choice of one of the plurality of answer options,
wherein the plurality of answer options comprise at least one answer of a first type which is unlikely to be selected by a human user and at least two answers of a second type, which have high probability of being selected by the human users and which reflect predetermined characteristics of the human user.

2. The computer-implemented method of claim 1, wherein difference between the answers of the first and the second type are obvious to the human user but not obvious to a computer.

3. The computer-implemented method of claim 1, wherein allowing or denying the access to the resource is based on a previous pattern of received choices of answer options.

4. The computer-implemented method of claim 3, wherein the access to the resource is granted when the request originator selected answers of the second type multiple times in the past.

5. The computer-implemented method of claim 1, further comprising storing information on the received choice of one of the plurality of answer options for a future use.

6. The computer-implemented method of claim 5, further comprising using the stored information on the received choice of one of the plurality of answer options to compute distribution of a parameter reflective of the request originator.

7. The computer-implemented method of claim 5, further comprising using the stored information on the received choice of one of the plurality of answer options to provide content to the request originator.

8. The computer-implemented method of claim 1, wherein the challenge question connects the request originator with a group of peers.

9. The computer-implemented method of claim 8, further comprising using received choices of a first plurality of request originators to identify the group of peers.

10. The computer-implemented method of claim 9, further comprising using the identified group of request originators to allow of deny access to subsequent request originators based on the corresponding choices of one of the plurality of answer options.

11. The computer-implemented method of claim 1, wherein the resource is a virtual private network service.

12. The computer-implemented method of claim 1, wherein if the access to the resource is denied, future requests within a predetermined time-out period are also denied.

13. The computer-implemented method of claim 1, wherein the plurality of the answer options are provided to the request originator in a pictorial form.

14. The computer-implemented method of claim 1, further comprising randomly varying an order of the plurality of the answer options.

15. The computer-implemented method of claim 1, wherein the access to the resource is only partially denied.

16. A computer-readable medium comprising a set of computer-executable instructions, which, when executed by one or more processors, cause the one or more processors to perform a method comprising:
a. Receiving a request to access a resource, the request being received from a request originator;
b. Providing to the request originator a response comprising at least one challenge question and a plurality of answer options responsive to the challenge question;
c. Receiving from the request originator a choice of one of the plurality of answer options; and
d. Allowing or denying the access to the resource based on the received choice of one of the plurality of answer options,
wherein the plurality of answer options comprise at least one answers of a first type which is unlikely to be selected by a human user and at least two answers of a second type, which have high probability of being selected by the human users and which reflect predetermined characteristics of the human user.

17. The computer-readable medium of claim 16, wherein difference between the answers of the first and the second type are obvious to the human user but not obvious to a computer.

18. The computer-readable medium of claim 16, wherein allowing or denying the access to the resource is based on a previous pattern of received choices of answer options.

19. The computer-readable medium of claim 19, wherein the access to the resource is granted when the request originator selected answers of the second type multiple times in the past.

20. A system comprising a central processing unit and a memory storing a set of instructions, the central processing unit being configured by the set of instructions to:
a. Receive a request to access a resource, the request being received from a request originator;
b. Provide to the request originator a response comprising at least one challenge question and a plurality of answer options responsive to the challenge question;
c. Receive from the request originator a choice of one of the plurality of answer options; and
d. Allow or deny the access to the resource based on the received choice of one of the plurality of answer options,
wherein the plurality of answer options comprise at least one answer of a first type which is unlikely to be selected by a human user and at least two answers of a second type, which have high probability of being selected by the human users and which reflect predetermined characteristics of the human user.
